(19) United States
(12) Patent Application Publication
(10) Pub. No.: US 2005/0286971 A1
(43) Pub. Date: Dec. 29, 2005

(54) Connectors for articulated tracks for vehicles and tracks and track components including such connectors

(76) Inventors: Paul Gibson, Durham (GB); David Arthur Palframan, Wakefield (GB)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/532,763

(22) PCT Filed: Oct. 22, 2003
(86) PCT No.: PCT/GB03/04556

§ 371 Date: Apr. 20, 2005

(30) Foreign Application Priority Data
Oct. 23, 2002 (GB) 0224636.1

(51) Int. Cl. F16B 1/00

(52) U.S. Cl. 403/396

(57) ABSTRACT

An end connector (1) for an articulated vehicle track includes a body portion (3) with passageways (10a,10b) for accommodating track pins (33) of adjacent track links. A bore (13a, 13b) passes through an intermediate part (11a, 1b) of the body portion perpendicular to the axes of the track pins and accommodates a securing bolt (17). A securing element (5) includes a first arm portion (19) which is retained on the body portion by the bolt and an angled second arm portion (21) having side edges (31a, 31b) which co-operate with grooves (35) in the track pins to retain the end connector on the track pins.

The present invention relates to tracks for articulated vehicles and to parts and components of such tracks and more especially to end connectors for such tracks.

Articulated vehicle tracks, such as those used on military, construction or agricultural vehicles often comprise a number of track sections or track links each of which accommodates two parallel track pins, suitably in appropriately sized bores. The track links may include a shoulder which assists in retaining the track on the vehicle. The track pins extend beyond the limits of the track link and are used to provide the articulation of the track and in connecting adjacent track links together. For the latter purpose, an end connector is used. The end connector includes a body part having first and second passageways for accommodating respectively the end parts of a first track pin of a first track link and a second track pin of an adjacent second track link. The end connector includes means for retaining the end connector on the track pins so that adjacent track pins of adjacent track links are thus joined together. Examples of end connectors can be seen in DE 27 08 538A, U.S. Pat. No. 3,594,048 and WO99/11506.

An important consideration in the design of tracks for articulated vehicles is the arduous conditions in which the vehicles and tracks must operate. For example, in the case of military vehicles such as tanks and armoured personnel carriers, the vehicle and track must be effective in conditions ranging from sub-zero Arctic temperatures to extremely hot desert temperatures and in mud, snow, sand, gravel, rain, water and darkness. It is also essential that the track components must allow the track to be replaced or repaired in the minimum possible time, bearing in mind that this may need to be done in battlefield conditions by an operative with gloved hands. Therefore, the components of the articulated track are desirably as simple and easily handled as possible.

The present invention seeks to provide an improved end connector for an articulated vehicle track and a track including one or more of such connectors.

According to a first aspect of the present invention there is provided an end connector for an articulated vehicle track comprising:
(a) a body portion including first and second side portions respectively at least partially defining first and second passageways adapted to receive first and second track pins of adjacent track links, first and second intermediate portions disposed between the first and second side portions and a bore passing through the first and second intermediate portions between and perpendicular to the track pins in use;
(b) a securing element;
(c) a securing bolt having a head portion and a shank portion which shank portion co-operates in use with the threaded bore; and
(d) means for securing the securing bolt on the body portion, wherein
   the securing element comprises first and second arm portions arranged at an angle with respect to each other, the first arm portion being secured in use between an outer surface of the first intermediate portion and the head portion of the securing bolt and the second arm portion including opposed marginal edges which are arranged in use to partially penetrate or overlie the respective first and second passageways.

In a preferred embodiment of this aspect of the invention, the first intermediate portion is shorter than the second intermediate portion in a direction parallel to the longitudinal axis of the track pins in use and an inner face of the second intermediate portion includes an abutment surface operative to co-operate with a leading edge of the second arm portion to resist movement of the second arm portion in a direction away from the body portion generally parallel to the longitudinal axes of the track pins in use.

Most preferably in this embodiment the abutment surface is defined by a wall of a channel formed in said inner face which channel operatively receives the leading edge of the second arm portion.

In a preferred variation of this aspect of the invention the first arm portion includes a hole for passage through the first arm portion of the shank portion of the securing bolt.

According to a second aspect of the invention there is provided a track link unit for an articulated vehicle track comprising
i) a track link including first and second track pins arranged parallel to one another and passing through the track link, each track pin including a radially directed groove towards an end thereof; and
ii) an end connector,
   wherein the end connector comprises:
(a) a body portion including first and second side portions respectively at least partially defining first and second passageways, the first passageway receiving a first track pin of a first track link and the second passageway being adapted to receive a second track pin of an adjacent second track link, first and second intermediate portions disposed between the first and second side portions and a bore passing through the first and second intermediate portions between and perpendicular to the track pins;
(b) a securing element comprising first and second arm portions arranged at an angle with respect to each other;
(c) a securing bolt having a head portion and a shank portion which shank portion co-operates with the threaded bore; and
(d) means for securing the securing bolt on the body portion,
   the first arm portion being secured between an outer surface of the first intermediate portion and the head portion of the securing bolt and the second arm portion including opposed marginal edges which are arranged to partially penetrate or overlie the respective first and second passageways and which first and second marginal edges co-operate with the respective radially directed grooves of the track pins to retain the end connector on the track pins.

Preferably in an embodiment of the second aspect of the invention, the first intermediate portion of the end connector is shorter than the second intermediate portion in a direction parallel to the longitudinal axis of the track pins and an inner face of the second intermediate portion includes an abutment surface operative to co-operate with a leading edge of the second arm portion to resist movement of the second arm portion in a direction away from the body portion generally parallel to the longitudinal axes of the track pins.

Most preferably in this embodiment, the abutment surface is defined by a wall of a channel formed in said inner face which channel operatively receives the leading edge of the second arm portion.

According to a third aspect of the invention there is provided an articulated vehicle track comprising:
i) a plurality of adjacent track links, each track link including first and second track pins arranged parallel to one another and passing through the track link, each track pin including a radially directed groove towards an end thereof; and
ii) a plurality of end connectors,
   wherein the end connectors comprise:
   (a) a body portion including first and second side portions respectively at least partially defining first and second passageways, the first passageway receiving a first track pin of a first track link and the second passageway receiving a second track pin of an adjacent second track link, first and second intermediate portions disposed between the first and second side portions and a bore passing through the first and second intermediate portions between and perpendicular to the track pins;
   (b) a securing element comprising first and second arm portions arranged at an angle with respect to each other;
   (c) a securing bolt having a head portion and a shank portion which shank portion co-operates with the threaded bore; and
   (d) means for securing the securing bolt on the body portion,
   the first arm portion being secured between an outer surface of the first intermediate portion and the head portion of the securing bolt and the second arm portion including opposed marginal edges which are arranged to partially penetrate or overlie the respective first and second passageways and which first and second marginal edges co-operate with the respective radially directed grooves of the track pins to retain the end connector on the track pins.

Preferably in an embodiment of this third aspect of the invention, the first intermediate portion of the end connectors is shorter than the second intermediate portion in a direction parallel to the longitudinal axes of the track pins and an inner face of the second intermediate portion includes an abutment surface operative to co-operate with a leading edge of the second arm portion to resist movement of the second arm portion in a direction away from the body portion generally parallel to the longitudinal axes of the track pins.

Most preferably in this embodiment the abutment surface is defined by a wall of a channel formed in said inner face which channel operatively receives the leading edge of the second arm portion.

According to a fourth aspect of the invention there is provided a vehicle including an articulated track according to the third aspect of the invention.

Preferably in all these aspects of the invention, the bore and the shank portion of the end connector have co-operating threads.

For a better understanding of the invention and to show how the same may be carried into effect, reference will be made by way of example only to the following drawings in which:

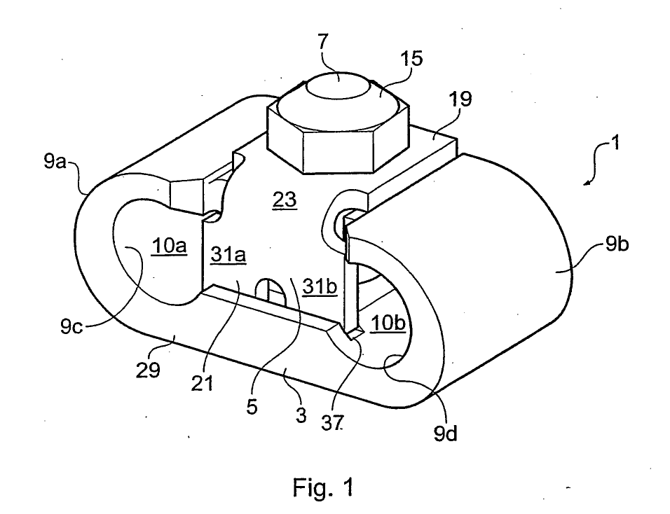

FIG. 1 is a perspective view of an assembled end connector according to the invention;

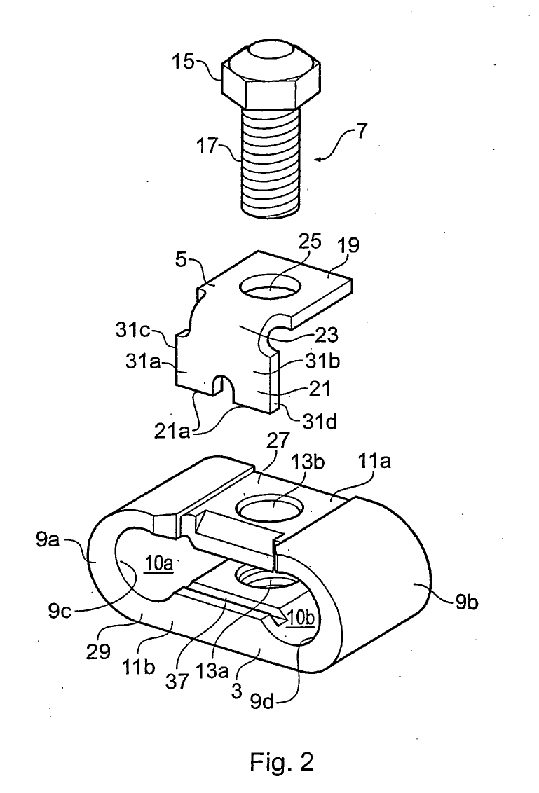

FIG. 2 is an exploded view of the end connector of FIG. 1; and

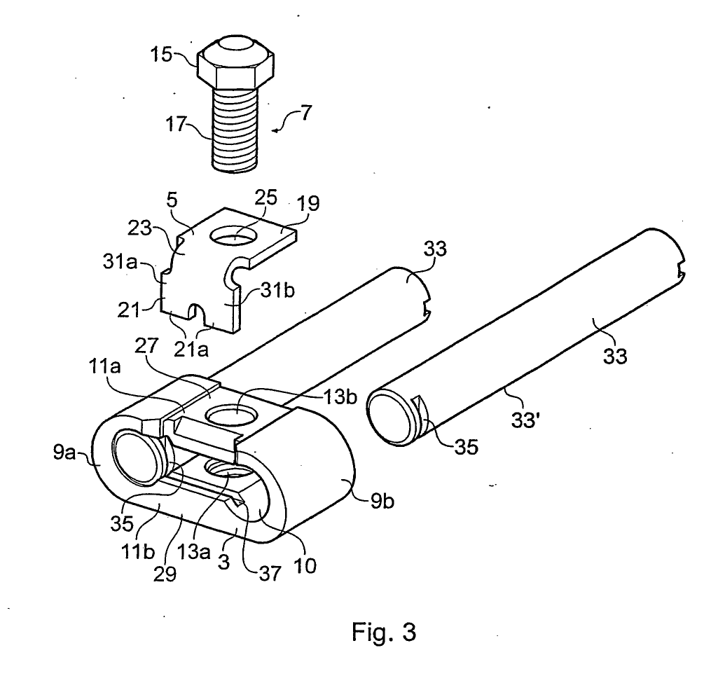

FIG. 3 is a partly exploded view showing how the end connector of FIG. 1 is mounted on track pins of an articulated vehicle track.

Referring now to the drawings, the end connector 1 comprises a body portion 3, a securing element 5 and a securing bolt 7. The body portion 3 includes first and second side portions 9a, 9b and first and second intermediate portions 11a, 11b. The side portions 9a, 9b and the intermediate portions 11a, 11b are all formed integrally such that the body potion 3 is in the form of a continuous loop. The side portions 9a, 9b have inner surfaces 9c, 9d which respectively at least partially define passageways 10a, 10b which in use of the end connector accommodate the ends of track pins 33. The passageways 10a, 10b are so sized and shaped as to conform closely with the cylindrical outer surface of the track pins 33. The intermediate portions 11a, 11b include a bore 13. Preferably the portion 13a of the bore which extends through the second intermediate portion 11b is threaded, the portion 13b extending through the first intermediate portion being plain.

The securing bolt 7 includes a head 15 and a threaded shank 17. The threaded shank 17 preferably engages the threaded part of the bore 13. Alternatively (but less preferred), the shank 17 of the bolt 7 may extend beyond the intermediate portion 11b and secured with a nut. The securing element 5 comprises first and second arm portions 19, 21 linked by a curved web portion 23. Preferably the first and second arm portions lie substantially at right angles to one another. The first arm portion 19 includes a hole or bore 25 sized to allow passage of the shank 17 of the securing bolt 7 but smaller than the head 15. The first arm portion 19 lies in the assembled end connector against an outer surface 27 of the first intermediate portion 11a and is secured in this position by the head 15 of the bolt 7, the shank 17 of the bolt passing through hole 25. The second arm portion 21 of the securing element 5 lies, in the assembled end connector, substantially parallel to an outer end face 29 of the end connector. The width of the second arm portion is selected so that marginal edges 31a, 31b overlap or lie partially within the passageways 10a, 10b.

Track pins 33 include towards their ends a radially directed groove or notch 35. The groove 35 has a planar base forming a chord of the circle described by the outer circumferential surface of the cylindrical track pins 33. Planar side walls of the groove 35 lie perpendicular to the planar base. The size of the groove 35, and especially the spacing of the side walls is selected to conform closely with the thickness of the second arm portion 21, more especially with the thickness of the marginal portions 31a, 31b. In FIG. 3, the track pin 33′ is shown rotated by approximately 180° about its longitudinal axis from its use position in order to illustrate the groove 35. In use, the radially directed grooves of the two track pins 33 joined by the end connector are arranged to face each other.

The end connector 1 is assembled on adjacent track pins of adjacent track links (not shown) to join the track pins (and hence the track links) together. In a first step, the track pins 33 are placed within the passageways 10a, 10b and arranged so that the grooves 35 are directed inwardly. This allows the securing element 5 to be mounted on the body portion 3 of the end connector 1 so that the marginal edges 31a, 31b of the second arm portion 21 lie within the grooves 35. In a much preferred arrangement, the depth of the grooves 35 and the width of the second arm portion 21 are selected so that in the assembled state, the side faces 31c, 31d of the marginal edges are in confronting relation to the planar base of the grooves 35. The first arm portion 19 of the securing element 5 is simultaneously mounted on the outer surface 27 of the first intermediate portion 11a and secured by location of the bolt 7 through the hole 25 and in the bore 13. Tightening of the bolt 7 serves both to secure the securing element 5 on the end connector between the head 15 of the bolt 7 and the outer surface 27 and to fasten the end connector on the track pins 33 by urging the intermediate portions 11a, 11b toward one another so that the body portion is compressed against the track pins.

Location of the marginal edges 31a, 31b of the second arm portion 21 in the grooves 35 of the track pins 33 serves to retain the end connector on the track pins 33 since the track pins 33 and the body portion 3 are thereby constrained from relative movement in a direction generally parallel to the longitudinal axes of the track pins 33. To remove the end connector from the track pins it is necessary firstly to remove the bolt 7 and then to remove the securing element 5 so that the marginal edges 31a, 31b of the second arm portion are released from the grooves 35.

By providing that the depth of the grooves 35 and the width of the second arm portion 21 are such that in the assembled state, the side faces 31c, 31d of the marginal edges are in confronting relation to the planar base of the grooves 35, a further advantage results in that the confronting relation of the side faces 31c, 31d and the planar bases of the grooves 35 prevents rotation of the track pins with respect to the end connector 1.

In a much preferred construction as illustrated in the drawings a further point of location is provided for the securing element 5 in the body portion 3. Thus, the leading end 21a of the second arm portion 21 is located in use against and abutment surface which restrains movement of the second arm portion 21 with respect to the body portion 3. In the illustrated embodiment this is achieved by providing that the first intermediate portion 11a is shorter in a direction parallel to the longitudinal axes of the track pins than the second intermediate portion 11b so that the leading end 21a of the second arm portion 21 can lie within a channel or groove 37 formed in the second intermediate portion 11b. The channel 37 is sized to conform with the thickness of the leading end 21a.

1. An end connector for an articulated vehicle track comprising:
(a) a body portion including first and second side portions respectively at least partially defining first and second passageways adapted to receive first and second track pins of adjacent track links, first and second intermediate portions disposed between the first and second side portions and a bore passing through the first and second intermediate portions between and perpendicular to the track pins in use;
(b) a securing element;
(c) a securing bolt having a head portion and a shank portion which shank portion co-operates in use with the bore; and
(d) means for securing the securing bolt on the body portion, wherein the securing element comprises first and second arm portions arranged at an angle with respect to each other, the first arm portion being secured in use between an outer surface of the fist intermediate portion and the head portion of the securing bolt and the second arm portion including opposed marginal edges which are arranged in use to partially penetrate or overlie the respective first and second passageways.

2. An end connector as claimed in claim 1 wherein the bore and the shank portion have co-operating threads.

3. An end connector as claimed in claim 1 wherein the first intermediate portion is shorter than the second intermediate portion in a direction parallel to the longitudinal axis of the track pins in use and an inner face of the second intermediate portion includes an abutment surface operative to co-operate with a leading edge of the second arm portion to resist movement of the second arm portion in a direction away from the body portion generally parallel to the longitudinal axes of the track pins in use.

4. An end connector as claimed in claim 3 wherein the abutment surface is defined by a wall of a channel formed in said inner face which channel operatively receives the leading edge of the second arm portion.

5. An end connector as claimed in claim 1 wherein the first arm portion includes a hole for passage through the first arm portion of the shank portion of the securing bolt.

6. A track link unit for an articulated vehicle track comprising
i) a track link including first and second track pins arranged parallel to one another and passing through the track link each track pin including a radially directed groove towards an end thereof; and
ii) an end connector,
wherein the end connector comprises:
(a) a body portion including first and second side portions respectively at least partially defining first and second passageways, the first passageway receiving a first track pin of a first track link and the second passageway being adapted to receive a second track pin of an adjacent second track link, first and second intermediate portions disposed between the first and second side portions and a bore passing through the first and second intermediate portions between and perpendicular to the track pins;
(b) a securing element comprising first and second arm portions arranged at an angle with respect to each other;
(c) a securing bolt having a head portion and a shank portion which shank portion co-operates with the threaded bore, and
(d) means for securing the securing bolt on the body portion, wherein
the first arm portion being secured between an outer surface of the first intermediate portion and the head portion of the securing bolt and the second arm portion including opposed marginal edges which are arranged to partially penetrate or overlie the respective first and second passageways and which first and second marginal edges co-operate with the respective radially directed grooves of the track pins to retain the end connector on the track pins.

7. A track link unit as claimed in claim 6 wherein the bore and the shank portion of the end connector have co-operating threads.

8. A track link unit as claimed in claim 6 wherein the first intermediate portion of the end connector is shorter than the second intermediate portion in a direction parallel to the longitudinal axis of the track pins and an inner face of the second intermediate portion includes an abutment surface operative to co-operate with a leading edge of the second arm portion to resist movement of the second arm portion in a direction away from the body portion generally parallel to the longitudinal axes of the track pins.

9. A track link unit as claimed in claim 8 wherein the abutment surface is defined by a wall of a channel formed in said inner face which channel operatively receives the leading edge of the second arm portion.

10. An articulated vehicle track comprising:
i) a plurality of adjacent track links, each track link including first and second track pins arranged parallel to one another and passing through the track link, each track pin including a radially directed groove towards an end thereof; and
ii) a plurality of end connectors,
wherein the end connectors comprise:
(a) a body portion including first and second side portions respectively at least partially defining first and second passageways, the first passageway receiving a first track pin of a first track link and the second passageway being adapted to receive a second track pin of an adjacent second track link, first and second intermediate portions disposed between the first and second side portions and a bore passing through the first and second intermediate portions between and perpendicular to the track pins;
(b) a securing element comprising first and second arm portions arranged at an angle with respect to each other;
(c) a securing bolt having a head portion and a shank portion which shank portion co-operates with the bore; and
(d) means for securing the securing bolt on the body portion the first arm portion being secured between an outer surface of the first intermediate portion and the head portion of the securing bolt and the second arm portion including opposed marginal edges which are arranged to partially penetrate or overlie the respective first and second passageways and which first and second marginal edges co-operate with the respective radially directed grooves of the track pins to retain the end connector on the track pins.

11. An articulated vehicle track as claimed in claim 10 wherein the bore and shank portion of the end connector have co-operating threads.

12. An articulated vehicle track as claimed in claim 11 wherein the first intermediate portion of the end connectors is shorter than the second intermediate portion in a direction parallel to the longitudinal axes of the Back pins and an inner face of the second intermediate portion includes an abutment surface operative to co-operate with a leading edge of the second arm portion to resist movement of the second arm portion in a direction away from the body portion generally parallel to the longitudinal axes of the track pins.

13. An articulated vehicle track as claimed in claim 12 wherein the abutment surface is defined by a wall of a channel formed in said inner face which channel operatively receives the leading edge of the second arm portion.

14-16. (canceled)

17. A vehicle including an articulated track as claimed in claim 10.
